(19) United States
(12) Patent Application Publication
(10) Pub. No.: US 2015/0135485 A1
(43) Pub. Date: May 21, 2015

(54) UPHOLSTERY CLIP FOR REMOVABLE ATTACHMENT TO RIGID SURFACES

(71) Applicant: Hope Global, Division of NFA Corp., Cumberland, RI (US)

(72) Inventors: Andrew W. Santin, Newton, MA (US); Carlos A. Neves, Cumberland, RI (US)

(21) Appl. No.: 14/534,104

(22) Filed: Nov. 5, 2014

Related U.S. Application Data
(60) Provisional application No. 61/901,545, filed on Nov. 8, 2013.

(51) Int. Cl. B60R 13/02; F16B 2/22

(52) U.S. Cl. CPC B60R 13/0206; F16B 2/22
USPC 24/293; 29/453

(57) ABSTRACT

A locking structure for the removable attachment of listing beads to structures comprising an upholstery clip that is provided with a clip base with attached counterpoised clip arm assemblies and a key assembly. The clip arm assemblies are constructed and arranged of legs and hooks and the key assembly is provided with a neck and a key. The clip arm assemblies have a narrow gap between the hooks to receive a listing and attached material. The upholstery clip removably engages with a hard anchor base that is attached to a rigid surface. The hard anchor base is provided with a receiving slot that is sized to removably receive and engage the key of the upholstery clip. The key assembly is inserted into the receiving slot and rotated through ninety degrees of motion to a locking position and is held in position by at least one detent.

### RELATED APPLICATIONS

This application claims the benefit of U.S. Provisional Application Ser. No. 61/901,545, filed Nov. 8, 2013, entitled UPHOLSTERY CLIP FOR REMOVABLE ATTACHMENT TO RIGID SURFACES, the entire disclosure of which is herein incorporated by reference.

### FIELD OF THE INVENTION

This invention relates to upholstery attachment mechanisms and similar resilient structures and, more particularly, but not limited, to removable upholstery clips for automotive applications.

### BACKGROUND OF THE INVENTION

Current fabric trim covers (upholstery), such as those used in vehicles, often carefully sculpted and shaped to produce a comfortable and aesthetically pleasing effect. As such, the fabric (typically cloth, vinyl or leather with an appropriate backing material) is secured at many locations along its surface to a resilient or flexible backing that defines the cushioned substrate of the upholstered item (for example, a seat bottom, cushion, back or headrest). The substrate is typically constructed from a resilient material. This resilient/flexible material can be synthetic foam (for example polyurethane and/or isocyanate-based foam) or another cushioning material, such as traditional rubberized horsehair, hog hair, and the like. In general, the close-fitting appearance of the upholstery to the substrate requires that the fabric be tacked down to the substrate at any intermediate dips, Vees or trenches in the surface. Otherwise, the fabric will tend to billow or “tent” at these non-planar surface features.

Traditional methods for tacking down trim covers at trenches entail the use of a plastic bead along the inner side of the trim cover. This bead is often located at an inner seam that is a sewn or welded, or otherwise adhered, joint between fabric pieces. Likewise the foam substrate includes an exposed metal wire that may be molded into the substrate along a trench in its surface during its construction. So-called “hog-rings,” consisting of bendable metal ringlets, are then secured to both the plastic bead and the metal wire. These rings are each applied by a tool, such as a hog-ring gun from a supply of wire. As each hog ring is secured, it forms an immovable, permanent joint between the fabric and the substrate. Clearly, this permanent joint is difficult to repair if needed and requires significant skill to create in the first place. In addition, this method of seat cover attachment leads to the development of injuries, such as carpal tunnel syndrome in employees who operate the hog ring tool over an extended period of time. Finally, the use of metal components may be undesirable where the seat includes electrical heating elements due to the metal's predisposition to conduct both heat and electricity.

More recently, trim covers have been secured to resilient substrates using detachable connections that allow repairs to be effected and are often more-easily applied without the used of highly skilled labor. In one example, one side of a hook and loop fastener is attached to a trench in the resilient substrate. The inner surface of the trim cover carries the opposing side of the fastener. This approach is reliable, but expensive, in terms of material wasted and consumed to attain a secure fit. It also requires a rather large-width trench to be formed in the resilient substrate to ensure a sufficient area of engagement between fastener sides.

Another recent approach involves the used of a series of clips that are molded into the trench as a foam substrate is manufactured and designed to secure a listing bead that is sewn or otherwise attached to the inside surface of the upholstery fabric—typically along a seam line. A version of this structure, and other prior art attachment mechanisms, are described in U.S. Published Patent Application US/2003/0215601 A1, entitled ATTACHMENT DEVICE, dated Nov. 20, 2003, by Peede, et al. the teachings of which are expressly incorporated herein by reference as useful background information. As described, each clip includes a pair of outwardly facing (with respect to the trim-cover-facing surface of the substrate) legs that together form a female projection with a pair of upper hooks or barbs that face toward each other, thereby defining a top-end funnel, leading into a cavity. The barbs define a narrow gap therebetween. This gap is smaller in width than the width of the cavity. The material and relative thickness of the legs is such that the barbs can be spread elastically apart so that an appropriately sized listing bead can pass between the legs to be thereafter trapped in the cavity against outward movement by the sprung-back barbs. In this case, the cylinder is a covered plastic or metal bead attached to a seam between two trim cover fabric pieces.

Improvements on such a clip design are provided in commonly assigned U.S. Pat. No. 8,099,837 B2, entitled LOW-PROFILE UPHOLSTERY CLIP FOR ATTACHING A BEAD TO A FOAM SUBSTRATE, by Santin, et al., the teachings of which are expressly incorporated herein by reference as useful background information. This clip and others contemplated in the prior art are adapted for embedding in the foam substrate, using the cured foam as an adhesive substance. However, many seat parts to which the upholstery may be adhered (e.g. a raised seat bolster) can be generally hard or rigid in surface characteristics. Thus, the use of a foam-seated clip is inappropriate in such areas.

Accordingly it is desirable to provide a clip that is adapted for placement on hard or rigid surfaces.

### SUMMARY OF THE INVENTION

This invention overcomes the disadvantages of the prior art by providing a clip that enables attachment of a listing bead or similar structures to a region having a hard or rigid underlying surface. The clip should be removably attachable to such surfaces and should be firmly mounted in place once the listing bead is attached. A removable upholstery clip according to an illustrative embodiment is defines a clip base with attached counterpoised clip arm assemblies and a key assembly. The clip arm assemblies are constructed and arranged with legs and hooks, and the key assembly is provided with a neck and a key. The clip arm assemblies are constructed and arranged to create a narrow gap between the hooks. The upholstery clip removably engages with a hard anchor base that is attached to a rigid surface. The hard anchor base is provided with a receiving slot that is sized to removably receive and engage the key of the upholstery clip. The key assembly is inserted into the receiving slot and rotated through ninety degrees of motion to a locking position. A pair of detents are constructed and arranged on the bottom of the receiving slot such that the key, when rotated ninety degrees, is removably captured and locked. The clip is constructed to removably engage a web having a listing along an edge. The clip is constructed and arranged of a unitary molded polycarbonate or other similar material. As the listing along the edge is pushed against the gap between the hooks, the hooks are urged apart and the legs flex outwards so as to admit the listing into a cavity between the clip arm legs. When the listing has passed the hooks and is inside the cavity, the legs rebound and the hooks act as barbs to retain and lock the listing and attached web material. The dimensions of the clip can be varied depending on the material to be attached and the tension on the clip. The receiving slot can define at least one of a diamond shape, an elongated elliptical shape or an elongated shape. Once the listing is engaged into the clip the linear configuration of the listing prevents the clip from rotating from the lock position there for preventing premature removal.

### BRIEF DESCRIPTION OF THE DRAWINGS

The invention description below refers to the accompanying drawings, of which:

FIG. 1 is a perspective view of an exemplary upholstery clip for removable attachment to rigid surfaces, according to an illustrative embodiment;

FIG. 2 is an exploded view of the illustrative upholstery clip and a fragment of a base for the clip, according to the illustrative embodiment;

FIG. 3 is a perspective view of the illustrative upholstery clip engaged with and locked into the base, according to the illustrative embodiment;

FIG. 4 is an end view of the upholstery clip, according to the illustrative embodiment;

FIG. 5 is a side view of the upholstery clip, according to the illustrative embodiment;

FIG. 6 is a bottom view of an exemplary upholstery clip having a key with an elongated elliptical shape, according to the illustrative embodiment;

FIG. 7 is a bottom view of an exemplary upholstery clip having a key with a diamond shape, according to the illustrative embodiment; and

FIG. 8 is a view of a plurality of clips employed in securing a tarp to a boat, according to a further embodiment.

### DETAILED DESCRIPTION

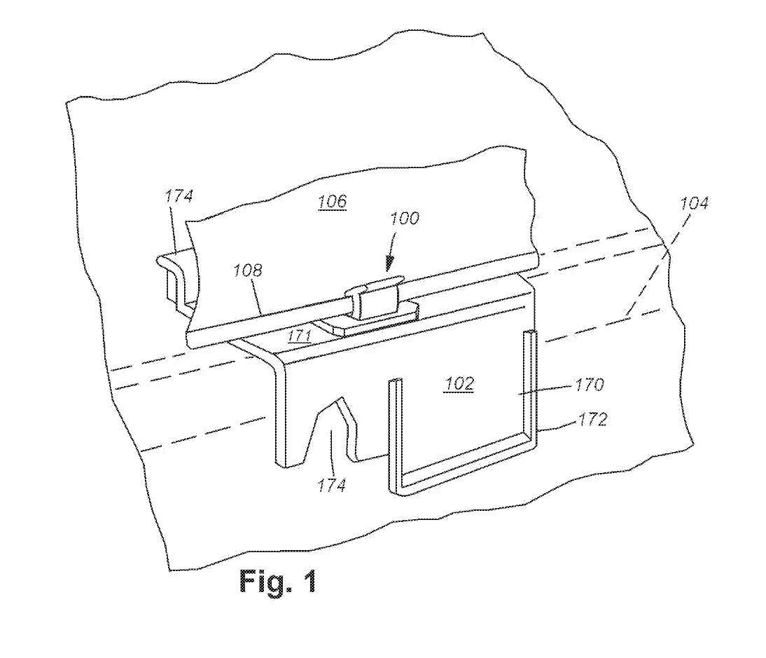

FIG. 1 shows an upholstery clip 100 for removable attachment to rigid surfaces removably engaged with and locked into a hard anchor base 102 that is in turn mounted and secured to a seat bolster 104. This clip is a locking structure that attaches material (for example, a seat cover) to another structure (for example, a seat frame). A portion of web 106 having a listing 108 along an edge is captured and retained by the clip 102. The web material can be a natural, synthetic or blended material. In an illustrative embodiment, the listing 108 is formed of a metal or elastomeric polymer and the web 106 is a non-woven material. The clip 100 and clip base 102 create a removable attachment for seat material to the structure of the seat. In the illustrative embodiment, the seat is a vehicle seat. In other embodiments, the seat can be a piece of furniture for non-vehicular uses, for example, a couch. A plurality of clips 100 and bases 102 can be arranged so as to attach the perimeter of the seat cover to the supporting structure of the seat. The anchor base 102 is a rigid and hard structure that can be formed of the same material as the clip 100. By way of a non-limiting example, the anchor base 102 is depicted in FIG. 1 as being provided with an “L” shape with a vertical wall 170 and a horizontal wall 171. The vertical wall 170 is provided with reinforcement structures 172 and a notch 172. The inner portion of the anchor base 102 is provided with an engaging structure 174 that can interface with structures located in the interior or on the exterior surface of the seat. In other embodiments, the size, number, dimensions and shapes of the engaging structures can vary, as well as the inclusion and geometry of the notch, depending on the desired application of the clip and the resultant shape of the anchor base to provide stable attachment of a plurality of clips to a seat or other structure.

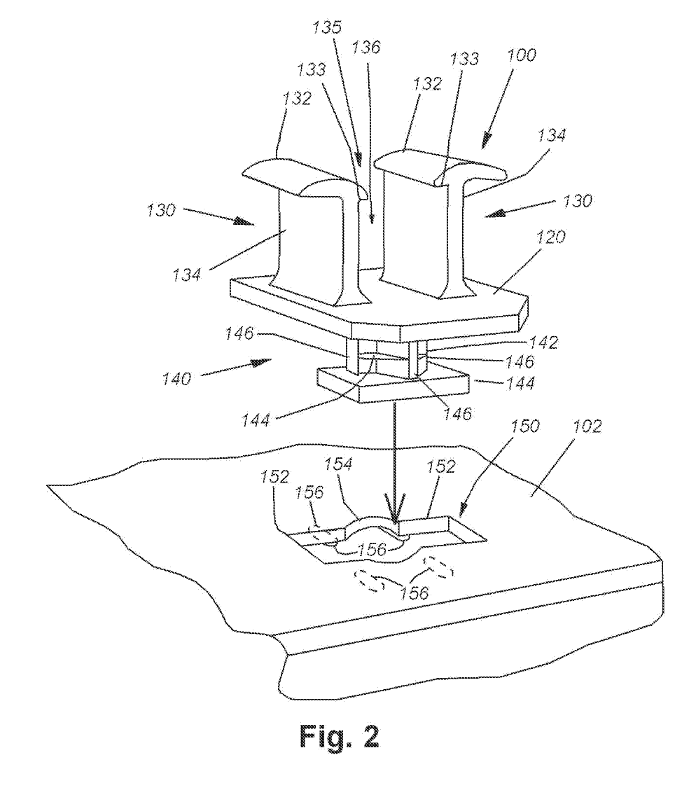

FIG. 2 is a view showing the upholstery clip 100 positioned above a portion of the base 102. The clip 100 is comprised of a clip base 120 having two counterpoised upright clip arm assemblies 130 extending from a generally planar clip base 120 and a key assembly 140 located below the base. Each discrete clip is a unitary structure, with the clip arm assemblies 130, clip base 120 and key assembly 140 being molded together as a single unit. Each clip arm assembly 130 is comprised of a hook 132 and a leg 134. The material and relative thickness of the legs 134 is such that the hooks 134 can be spread elastically apart so that an appropriately sized listing (not shown) can pass between the legs to be thereafter trapped in the cavity 136 against outward movement by the sprung-back hooks. In general, the clip material should be durable, capable of withstanding reasonable levels of heat and pressure and flexible so as to provide a springy material.

The clip includes a base 120 having a relatively thin cross section and an increased surface area adapted to act as a stable support against the anchor base 102. The key assembly 140 is comprised of a neck 142 and a key 144. The neck 142 connects the key 144 to the clip base 120. In the illustrative embodiment, the neck is cruciform in profile. In other embodiments, the neck 142 can have a profile that is rectilinear or circular in profile. The neck 142 is depicted as having supports 144 arranged between the ribs 146 that provide a resistance against torsional forces. The neck 142 should have sufficient thickness and width to endure ordinary stresses during its lifecycle.

The clip 100 attaches to the hard anchor base 102 by removable insertion of the key assembly 140 into a receiving slot 150 that is a through-hole in the anchor base 102. The shape of the receiving slot 150 is constructed and arranged to receive the key assembly 140 and is sized appropriately to provide passage of the key assembly with obstruction or impingement. The ends 152 of the slot 150 are shaped to match the key 144. A circular well 154 located at and around the midpoint of the slot 150 is sized to provide for rotation of the neck 142 when engaged in the slot. A pair of detents constructed on the bottom surface of the anchor base 102 are located on either side of the slot 150 at the well 154 such that when the key is inserted through the slot and the clip is rotated 90 degrees, the detents “capture” the key 144 and form a removable locked and fully engaged structure. Note that the detents secure the clip rotatably while the listing is attached. The orientation and expanse of the listing maintains rotational stability once a seat cover is fully secured. Thus, the detents can removably apply pressure to the clip. Alternatively, the detents can be arranged with a depth and/or geometry that provides permanent or semi-permanent attachment of the clip.

The arm assemblies 130 each include a hook 132 that together help to guide and/or funnel the listing into the gap 135 and into the cavity 136. In addition, the hooks 132 each define an inner shoulder 133 that restricts outward movement of the listing, or other member, once it is forcibly inserted through gap 135. The elasticity of the legs 134 provides for a first small movement of the respective inner shoulders 133 away from each other so that the width of the gap is momentarily increased to accommodate the insertion of the listing and then a second small movement of the inner shoulders towards each other to return to their original orientation and original gap width.

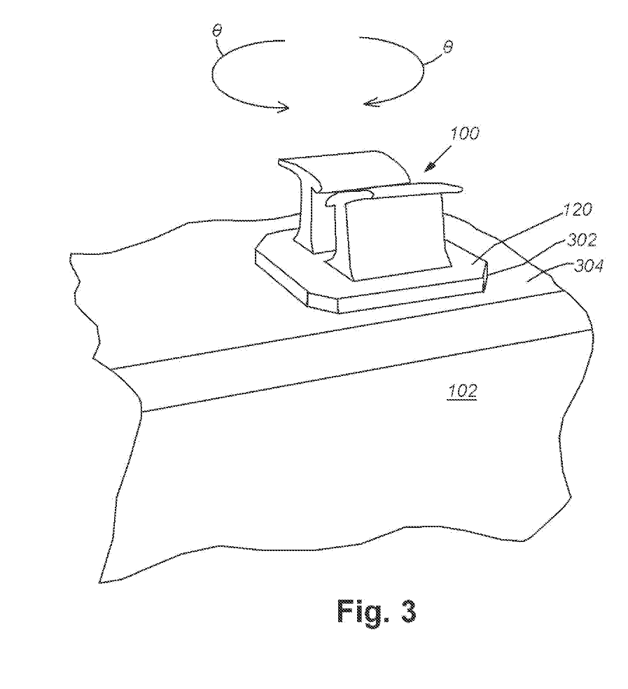

The rotation of the clip 100 when the key assembly 140 is inserted into the receiving slot 150 of the anchor base 102 to lock the clip is depicted in FIG. 3. The rotation passes through an angular movement having a degree of rotation θ of approximately 90 degrees. In other embodiments, the degree of rotation θ can be greater or lesser. When the clip has been rotated to 90 degrees, the key 144 is removably captured by the detents 156. The completed insertion of the clip 100 into the anchor base 102 and locking engagement of the clip 100 with the anchor base 102 creates an attachment for securing the web 106 into the clip 100. The material of the web 106 is pulled taut and the listing 108 is forced into the clip gap 135, causing the arm assemblies 130 to open and then close to capture the listing and secure the attached web 106. When locked in place, the bottom base surface 302 of the clip 100 is in contact with the top surface 304 of the anchor base 102. The detents prevent counter-rotation and misalignment. A plurality of more than one clip can be presented in an array to removably hold a segment of web material. To remove the material, an upward force is applied in a vector away from the clip 100. This causes the listing to come in contact with the bottom of the hooks, in turn causing the clip arms 130 assemblies to flex outward and the gap to widen, releasing the listing. The clip 100 can be removed and/or replaced by removing the listing and rotating the empty clip 90 degrees. This aligns the key with the receiving slot and provides removal of the key and neck from the anchor base.

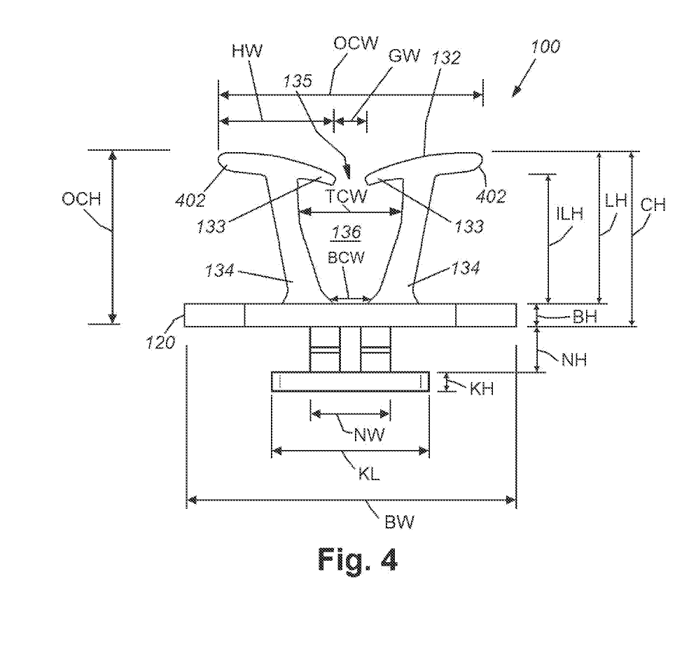

FIG. 4 depicts the relative dimensions of the clip 100. The overall clip height CH from the bottom base surface 302 to the top of the hook 132 is approximately 10 mm. The height ILH of the legs 134 along the inside surface next to the cavity 136 is approximately 5 mm. The height LH from the base 120 to the top of the hook 133 is approximately 8 mm. The gap 135 has a width GW of approximately 1.5 mm. The cavity 136 has a top width TCW of approximately 5 mm and a bottom cavity width BCW of approximately 3 mm. The width HW of each hook 132 is approximately 5 mm. The overall clip width OCW from one outermost hook edge 402 to the other is approximately 13 mm. The clip base height BH is approximately 1.5 mm. The neck height NH is approximately 2.5 mm. The key height KH is approximately 1 mm. The overall clip height OCH from key to the hooks is approximately 14 mm. The neck width NW is approximately 4 mm. The key length KL is approximately 8 mm and the base width BW is approximately 11 mm. In other embodiments, the size and width can vary for use with various fabrics and fabric thickness, as well as the tensions on the web.

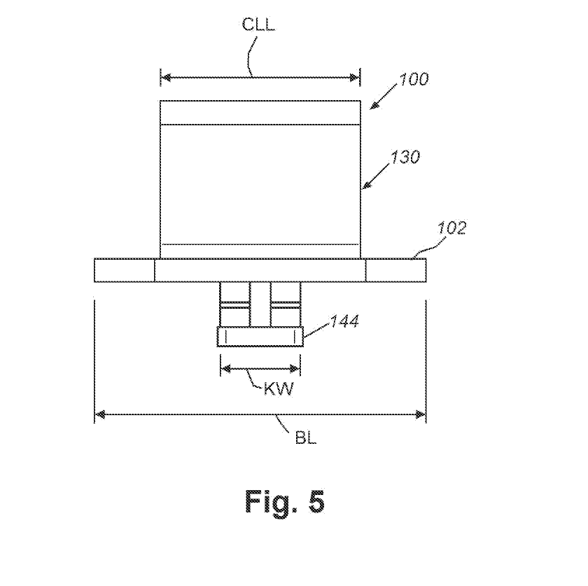

The length CLL of the clip arm assemblies 130 is approximately 8 mm, as shown in FIG. 5. The base length BL is approximately 15 mm. The key width KW is approximately 4 mm.

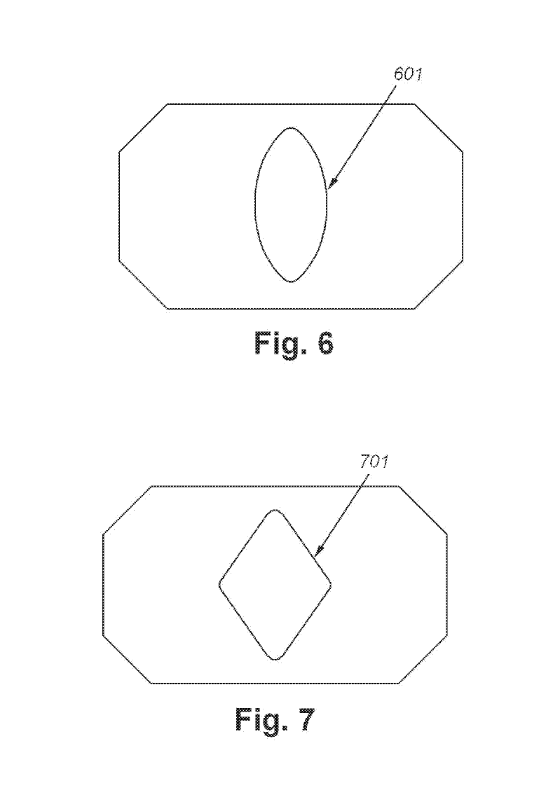

As depicted above, the illustrative key 144 is rectilinear in shape. In other embodiments, a key 601 can have an elongated elliptical shape, as shown in FIG. 6. The corresponding receiving slot in the anchor base has a similar shape.

FIG. 7 depicts a further embodiment having a key 701 with a diamond shape. In other embodiments, the key and slot can define another elongated rate.

It is contemplated that the illustrative clips can be clips can be arranged on a roll or strip and individually removed for assembly such as detailed in commonly owned U.S. Pat. No. 8,091,184, entitled FESTOONED TRIM CLIP SYSTEM AND METHOD FOR ATTACHING FESTOONED CLIPS TO A SUBSTRATE by Santin, et al.

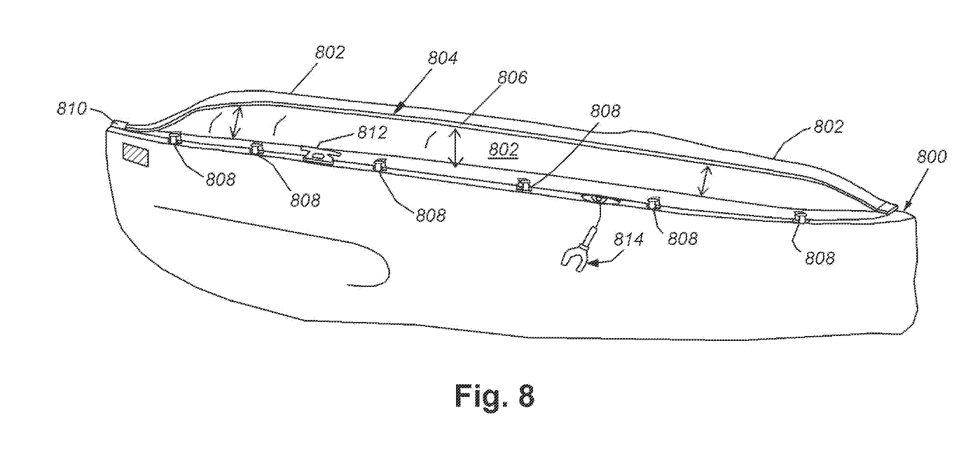

The clips can be used to removably secure tarps on equipment or vehicles, for example, boats. FIG. 8 is an exemplary embodiment showing a boat 800 with a tarp 802 partially attached. The edge 804 of the tarp is provided with a beaded listing 806 that can removably engage the clips 808 in the manner described above. Clip 810 has locked a portion of the listing. The clips are arranged with sufficient spacing so as not to interfere with various features along the side of the boat, for example, a cleat 812 and an oarlock 814. The anchor bases with receiving slots can be attached to the boat (for example, with screws and/or adhesives) or formed into the boat itself during the manufacturing process. Alternatively, the clips can be arranged along a mast or jib boom for receiving the edges of a removable sail cover. The clips can be mounted onto motorcycle sidecars or other vehicles that have a removable covering (trucks, all terrain vehicles, open cockpit aircraft, watercraft, and the like. It is further contemplated that the material being attached can be transparent. For example, removable side curtains on a vehicle.

The foregoing has been a detailed description of illustrative embodiments of the invention. Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments of the apparatus and method of the present invention, what has been described herein is merely illustrative of the application of the principles of the present invention. For example, the clip can be used to secure upholstery coverings to living room furniture or other household furniture. The placement and spacing between clips can vary. Arrangements of clips on a frame structure can provide a temporary structure for use as a greenhouse or garden house with removable panels for easy assembly and disassembly. The clips are removably secured so that they can be removed and damaged or replacement covering material substituted. The clips can be used to mount canopies or tenting. Different materials and the stresses upon the clips can increase the dimensions and thicknesses of the clips. The anchor base can be a formed structure that is part of the underlying structure. The material of the clip and anchor base can be a polycarbonate or other similar material. More generally, as used herein the directional terms, such as, but not limited to, “up” and “down”, “upward” and “downward”, “rearward” and “forward”, “top” and “bottom”, “inside” and “outer”, “front” and “back”, “inner ” and “outer”, “interior” and “exterior”, “downward” and “upward”, “horizontal” and “vertical” should be taken as relative conventions only, rather than absolute indications of orientation or direction with respect to a direction of the force of gravity. Accordingly, this description is meant to be taken only by way of example, and not to otherwise limit the scope of this invention.

What is claimed is:

1. An upholstery clip for removable attachment to rigid surfaces comprising:
a clip base with attached counterpoised clip arm assemblies and a key assembly,
wherein the clip arm assemblies define legs and hooks, and
the key assembly defines a neck and a key.

2. The upholstery clip as set forth in claim 1 wherein the clip removably engages with a hard anchor base that is attached to a rigid surface.

3. The upholstery clip as set forth in claim 2 wherein the hard anchor base is constructed and arranged with a receiving slot that is sized to removably receive the key assembly of the upholstery clip.

4. The upholstery clip of claim 3 wherein the receiving slot in the anchor base defines at least one of a diamond shape, an elongated elliptical shape or an elongated shape.

5. The upholstery clip as set forth in claim 3 wherein the key assembly of the upholstery clip is inserted into the receiving slot of the hard anchor base and the clip is rotated ninety degrees when the key has passed through the anchor base.

6. The upholstery clip as set forth in claim 5 wherein the hard anchor base has at least one detent that captures the key after rotation within the base and prevents counter-rotation and misalignment of the clip.

7. The upholstery clip as set forth in claim 1 wherein the hooks are arranged so as to removably capture a listing and attached web material.

8. The upholstery clip as set forth in claim 1 wherein a plurality of more than one clips are arranged in an array to removably hold a segment of web material.

9. The upholstery clip of claim 8 wherein the counterpoised clip arm assemblies are constructed and arranged with a gap between the inner surfaces of the respective hooks for receiving an inserted listing and web material.

10. A method for attaching material coverings to a structure comprising the steps of:
attaching an anchor base to a structure;
inserting a key assembly of a clip into a receiving slot in the anchor base;
rotating the clip 90 degrees within the receiving slot; and
inserting a listing along the edge of the material through a gap between the clip hooks into a cavity.

11. The method of claim 10 wherein the structure to which materials are attached is a seat for a vehicle.

12. The method of claim 10 wherein the structure to which materials are attached is a boat.
